(19) United States
(12) Patent Application Publication
(10) Pub. No.: US 2018/0210084 A1
(43) Pub. Date: Jul. 26, 2018

(54) OPTOELECTRONIC SENSOR AND METHOD OF DETERMINING THE DISTANCE OF AN OBJECT IN A MONITORED ZONE

(71) Applicant: SICK AG, Waldkirch (DE)

(72) Inventors: Ulrich ZWÖLFER, Waldkirch (DE); Alexander BOHLI, Waldkirch (DE); Michael ALBERT, Waldkirch (DE)

(21) Appl. No.: 15/876,466

(22) Filed: Jan. 22, 2018

(30) Foreign Application Priority Data
Jan. 26, 2017 (DE) 10 2017 101 501.9

(51) Int. Cl. G01S 17/10; G01S 7/486

(52) U.S. Cl. CPC G01S 17/10; G01J 2001/4466; G01S 7/4863; G01S 7/4865

(57) ABSTRACT

An optoelectronic sensor for determining the distance of an object having a light transmitter for transmitting a light pulse; having a SPAD light receiver with a measurement reception element and a reference reception element; and having an evaluation unit that is configured to determine a time of flight between the transmission of the light pulse and the reception of the remitted light pulse and from this the distance of the object from the received signals of the measurement reception element and of the reference reception element. The invention further relates to a method of determining an object in a monitored zone.

The invention relates to an optoelectronic sensor and to a method of determining the distance of an object in a monitored zone in accordance with the preamble of the respective independent claim.

Optoelectronic sensors are available in a wide spectrum that ranges from one-dimensional light barriers and light sensors over laser scanners to cameras. In distance-measuring systems, a distance from the object is also measured in addition to the pure object detection. Distance sensors in accordance with the time of flight principle for this purpose measure the time of flight of a light signal that corresponds to the distance via the speed of light. In a pulse time of flight process, a brief light pulse is transmitted and the time up to the reception of a remission or reflection of the light pulse is measured. Alternatively, in a phase process, transmitted light is amplitude modulated and a phase shift between the transmitted light and the received light is determined, with the phase shift likewise being a measure for the time of flight.

Important parameters for distance-measuring sensors include high ranges and the ability to recognize objects with high remission and also with low remission. The spread between near and distant objects is substantial, in particular between different remissions of, for instant shiny surfaces down, for example, to black velvet. There is therefore a need for highly sensitive reception systems that detect even a few photons where possible and additionally cover very large dynamic ranges of >100 dB.

Conventionally, avalanche photodiodes (APDs) are used to increase the sensitivity in some optoelectronic sensors. The incident light here triggers a controlled avalanche effect. The charge carriers generated by incident photons are thereby multiplied and a photocurrent is produced that is proportional to the received light intensity, but that is in this respect substantially larger than with a simple PIN diode.

An even greater sensitivity is achieved with avalanche photodiodes that are operated in the so-called Geiger mode (SPADs, single-photon avalanche diodes). In this respect, the avalanche photodiode is biased above the breakdown voltage such that a single charge carrier released by a single photon can already trigger an avalanche that is no longer controlled and that then recruits all the available charger carriers due to the high field strength. The avalanche then comes to a halt (passive quenching) and is no longer available for the detection for a certain dead time. It is alternatively also known to recognize and quench the avalanche from the outside (active quenching). Reference is made by way of example with respect to these and further general properties to the article Eisele, Andreas, et al. “185 MHz count rate, 139 dB dynamic range single-photon avalanche diode with active quenching circuit in 130 nm CMOS technology.” Int. Image Sensor Workshop (IISW), Onuma, Hokkaido, 2011.

A SPAD thus counts single events like a Geiger counter. SPADs are not only highly sensitive with amplification factors of up to 10⁸, but are also comparatively inexpensive. They can additionally be integrated on a circuit board with little effort. The fact is a special feature that a minimal interference event such as an external light photon or dark noise also generates the same maximum received signal as a utilized light signal. To limit these effects, a plurality of SPADs are evaluated together in practice.

Not only the received point in time, but also the starting point in time have to be known exactly for the exact determination of the time of flight. Non-constant delays in the electrical signal paths and in the actual point in time of the optical pulse generation result here due to environmental changes. Some known distance-measuring sensors therefore have an optical reference path. The same SPAD light receiver is used for measurement and calibration in EP 2 475 957 B1. The reference path can, however, only be used by variable beam deflection mirrors instead of the measurement path. This does not deliver a true reference in the sense of a starting point in time for the same measurement so that PVT instabilities or other changes over short time scales are not taken into account.

EP 2 017 651 B2 discloses a time of flight camera whose image sensor has a plurality of reference pixels of different sensitivity that are separated from the remaining pixels by an optical screening. The reference, however, does not relate to the time of flight here, but to the intensity. Since a phase method is used, it would also not be possible at all to produce a sensible reference point in time since when the light transmitter is activated does not play any role in a phase method.

In the ideal case, a distance-measuring sensor has the capability to be able to measure or switch directly from the front sensor screen and thus from a distance of zero. However, the light pulses now have a full width at half maximum that is typically not below 500 ps. Short time of flight times within this time range cannot be determined with conventional reception circuits due to optical overlaps of the transmitted pulse and the received pulse. A blind region thus results for very short distances in which no measurement values are delivered. Said 500 ps, for example, correspond to a double optical path there and back of 7.5 cm. In principle, the blind region can be further reduced by smaller pulse widths. However, this comes up against technical limits and even earlier against economic limits.

It is therefore the object of the invention to improve the time of flight measurement in a distance-measuring sensor.

This object is satisfied by an optoelectronic sensor and by a method for determining the distance of an object in a monitored zone in accordance with the respective independent claim.

A sensor of this category measures, as customary by transmitting and receiving light pulses, the time of flight up to an object and determines its distance from this via the constant speed of light. More complicated shapes such as double pulses or even pulse codes are also conceivable here. The light reception elements are avalanche photodiode elements that can each be biased by a bias voltage above a breakdown voltage and are thus operable in a Geiger mode, or are in other words SPADs. At least one light reception element as the reference reception element receives a portion of the light pulse as a reference pulse directly, that is within the sensor without the optical path up to the object and back, in order thus to take account of internal delays and drifts. At least one further light reception element is provided for the reception of the light pulse remitted by the object.

The invention now starts from the basic idea of carrying out a separate reference time measurement and time of flight measurement and of subsequently forming the difference. For this purpose, both time measurements are started together by way of an electric start signal, in particular the electric start signal or laser trigger for the generation of the transmitted light pulse. The time measurements are ended by reception of the reference pulse or of the remitted light pulse. The starting point in time of the time measurements then drops out through difference formation and exactly the time of flight on the optical measurement distance between the sensor and the object remains.

The invention has the advantage that a blind region for very near distances is avoided by the two separate time measurements. The recognition and measurement of objects up to the front sensor screen is possible independently of the transmitted pulse width here. Any internal delays, including fluctuations (PVT), are taken into account by the reference time measurement. The extremely high sensitivity of the avalanche photodiode elements in Geiger mode provides that measurements also remain possible at large ranges or at low remission. A pulsed system provides advantages over a phase method with respect to mutual influencing and ambiguity problems. The measurement system can be implemented in a very compact manner in a housing, the reception system can even be implemented on a single chip. The light receiver and thus the sensor be produced in a very robust and inexpensive manner.

The evaluation unit is preferably configured to start the time of flight measurement with an edge of the electric start signal and/or to end it with an edge of the remitted light pulse, in particular the respective first edge. The use of an edge as the trigger provides complete independence from the pulse width. The shape and time duration following the edge of the pulse no longer has any influence on the time measurements. It is therefore particularly advantageous to use the first edge at the start pulse that rises with a usual pulse shape.

The evaluation unit is preferably configured to start the reference time measurement with an edge of the electric start signal and/or to end it with an edge of the reference pulse, in particular the respective first edge. The reference time measurement thus relates to an edge having the already named advantages and additionally having an improved comparability of the reference time measurement and the time of flight measurement.

The evaluation unit is preferably configured to carry out a plurality of time of flight measurements using a plurality of measurement reception elements or groups of measurement reception elements and to evaluate the times of flight thus determined together to determine the distance of the object. A statistical evaluation thus takes place over the different measurement reception elements, for example by summing or cumulating all the time of flight measurements in a histogram with a subsequent evaluation of the histogram. Since individual avalanche photodiode elements in the Geiger mode can trigger due to a random event or a dark noise event, it can be advantageous to combine a plurality of avalanche photodiode elements to a group and to have them carry out a time of flight measurement together.

The evaluation unit is preferably configured to repeat the reference time of flight measurement and the time of flight measurement and to evaluate the times of flight thus determined together to determine the distance of the object. A greater statistical basis thereby results and thus an improved measurement accuracy additionally or alternatively to a multiple measurement by a plurality of measurement reception elements.

A plurality of reference reception elements are advantageously provided and the evaluation unit ends the reference time measurement as soon as a minimum number of reference reception elements have received the reference pulse. Unlike a plurality of measurement reception elements that can also be useful in a large number of many thousands and more, just a few, for example four to eight, reference reception elements are sufficient. They then decide together when the reference pulse was received, for instance as soon as a minimum number m of the total of n reference reception elements have triggered, in the borderline case in particular by an AND operation of all n reference reception elements. It is the purpose of such a decision or of another collective decision of the reference reception elements to reliably distinguish between the reception of the reference pulse and a random event. A single reference reception element could be triggered, for example, by dark nose and could then deliver practically any desired reference time measurement.

A plurality of reference reception elements are preferably provided and the evaluation unit carries out the reference time measurement multiple times with the reference reception elements or groups of reference reception elements. A more exact result of the reference time measurement thereby results by averaging or the like. The reference time measurement over a group of reference reception elements should again compensate the risk that a single reference reception element contributes an arbitrary value due to a random event.

The evaluation unit preferably has at least one respective TDC for the reference time measurement and the time of flight measurement. TDCs (time-to-digital converters) are proven components to carry out the time measurements and that practically work as stopwatches that are started and stopped by the electric start signal and the reference pulse or the remitted light pulse. The TDCs can be associated with a light reception element, with a group of light reception elements, or can be variably associated. They are preferably implemented directly at the pixels or light reception elements or at least on the same chip.

A light return element is preferably arranged in the sensor to conduct the reference pulse to the reference reception element. The transmitted light pulse is thus partly, so-to-say, optically short circuited. The light return element can be designed in different manners, for instance as a kind of transmitting tube or as a mirror.

The at least one reference reception element is preferably separated from the remaining light reception elements by an optical barrier. Optical crosstalk is thereby avoided. The reference pulse can accordingly not impact the measurement reception elements and the remitted light pulse cannot impact the reference reception elements, with the latter hardly being of importance for the measurement due to the time sequence. Avalanche photodiode elements in the Geiger mode are particularly sensitive to optical crosstalk because they are set into their dead time and are then possibly no longer available for the actual measurement.

The sensor is preferably configured as a laser scanner having a light transmitter and a movable deflection unit for a periodic deflection of the light beam in the monitored zone. All known concepts such as oscillating mirrors or rotating mirrors or a movable measurement head can be considered as the scan mechanism. The received light is typically periodically deflected, with there also being scanners, however, that use a static matrix chip and track an active pixel group by electronic control depending on the measurement direction.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

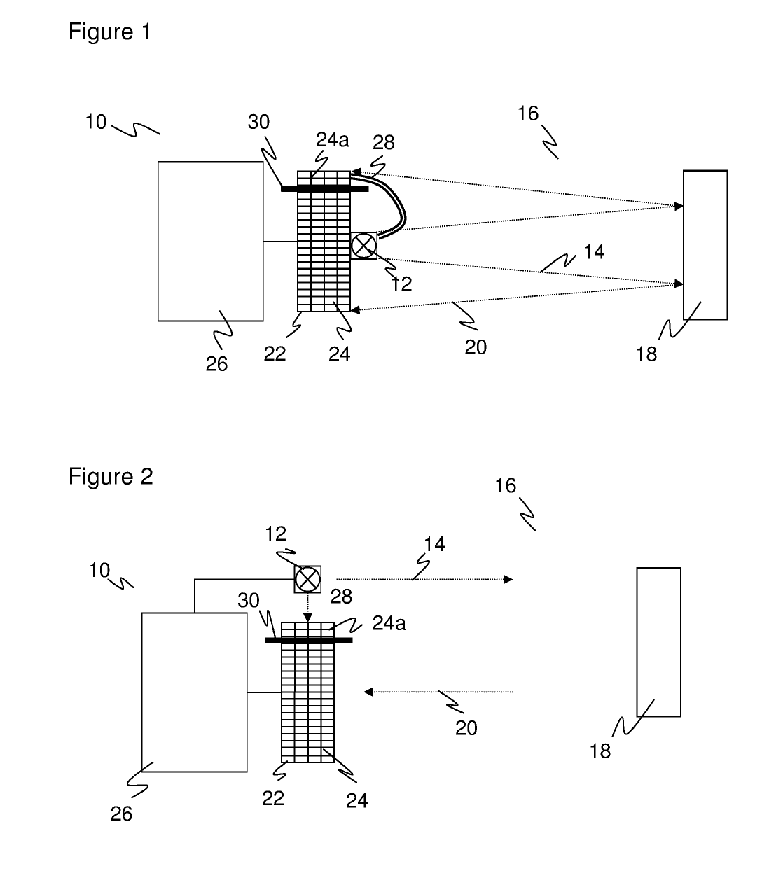

FIG. 1 a schematic representation of a distance-measuring sensor in a coaxial arrangement;

FIG. 2 a schematic representation of a distance-measuring sensor in an alternative biaxial arrangement;

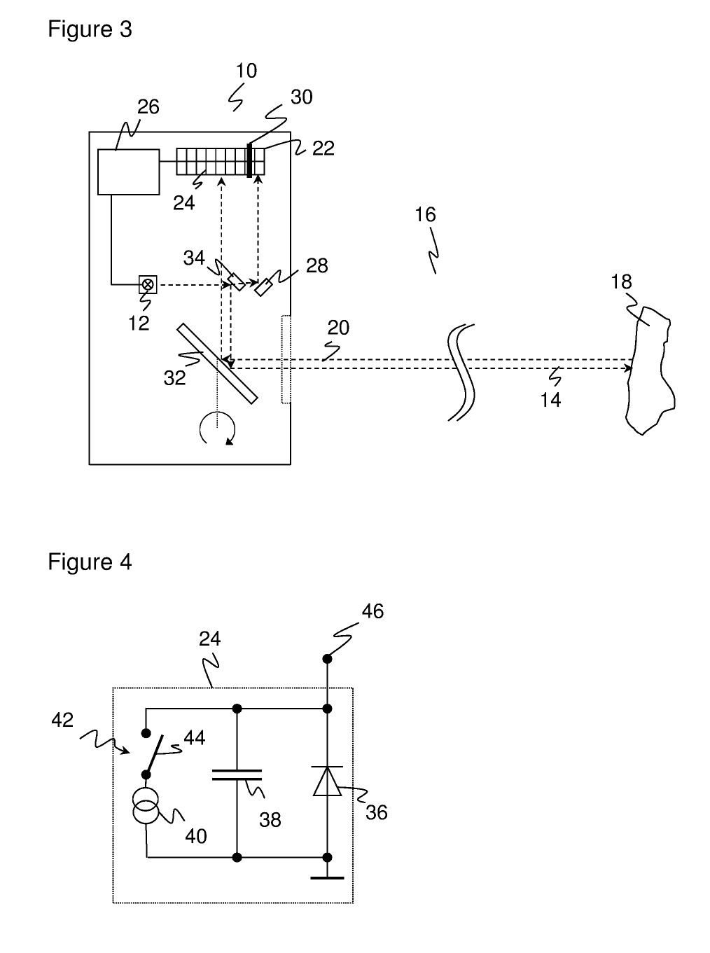

FIG. 3 a schematic representation of a distance-measuring sensor in an embodiment as a laser scanner;

FIG. 4 a simplified equivalent circuit diagram of a single avalanche photodiode in Geiger mode for explaining its functional principle;

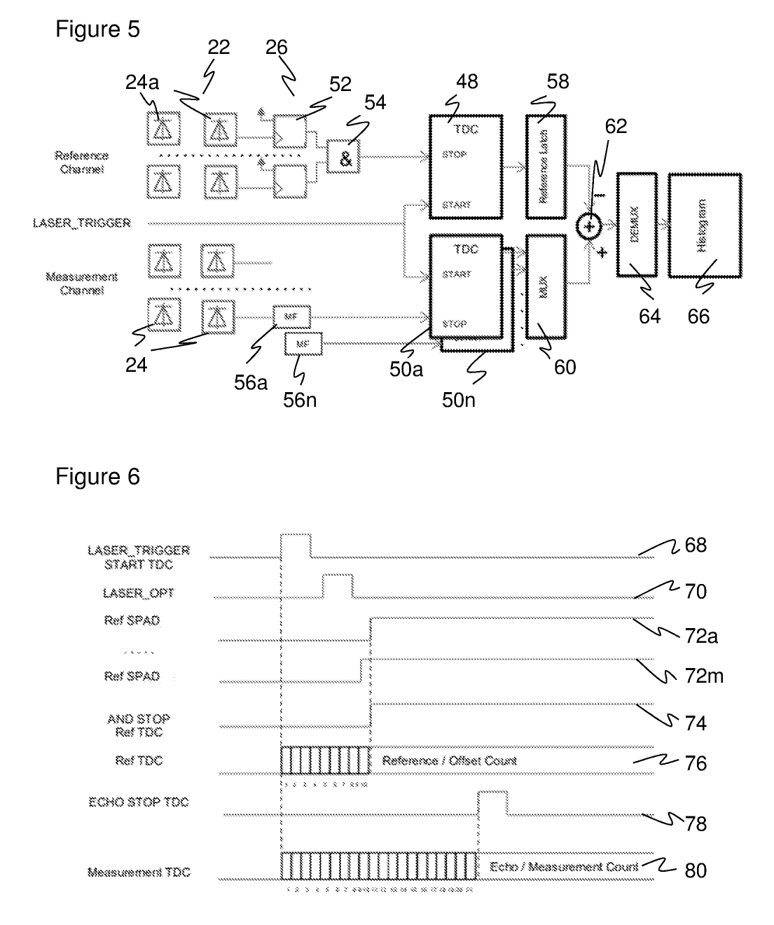

FIG. 5 a block diagram of the reception path of a distance-measuring sensor with a reference and measurement channel; and

FIG. 6 a representation of the signals at different points of the reception path in accordance with FIG. 5 for explaining the measurement method.

FIG. 1 shows a simplified schematic block diagram of an optoelectronic sensor 10 in an embodiment as a single-beam light scanner. A light transmitter 12, for example an LED or a laser light source, transmits a light pulse 14 into a monitored zone 16. If it is incident on an object 18 there, some of the light pulse is remitted or reflected and returns to a light receiver 22 as a remitted light pulse 20. This light receiver 22 has a plurality of light reception elements 24, 24a that are preferably configured as avalanche photodiodes in Geiger mode or SPADs. The received signals of the light reception elements 24, 24a are read by a control and evaluation unit 26 and are evaluated there.

A light return element 28, here by way of example in the form of a light guide, conducts some of the transmitted light pulse 14 directly back to the light receiver 22 as a reference pulse. The light reception elements impacted by the reference pulse are sometimes called reference reception elements 24a, the other light reception elements are called measurement reception elements 24. An optical barrier 30 is optionally provided therebetween to prevent optical crosstalk or back-glare. The reference reception elements 24a should preferably additionally be well protected against extraneous light.

The light receiver 22 shown in FIG. 1 is in one part, in particular a single chip that comprises both the measurement reception elements 24 and the reference reception elements 24a. Alternatively, a respective reception element, preferably an SPAD array, can be provided for the measurement reception elements 24 and the reference reception elements 24a. This increases the construction effort a little, but facilitates the optical separation.

The sensor 10 is distance measuring. For this purpose, the control and evaluation unit 26 determines a time of flight from the transmission of the light pulse 14 up to the reception of the remitted light 20 and converts it into a distance via the speed of light. In this distance measurement, the reference information of the reference pulse received in the reference reception elements 24a is taken into account. The time of flight measurement will be explained in more detail further below with reference to FIGS. 5 and 6.

The sensor 10 has further elements in a practical embodiment, in particular transmission and reception optics and connectors that will not be looked at here for reasons of simplicity. The separation into light receiver 22 and control and evaluation unit 26 in FIG. 1 is also conceivable in practice, but primarily serves for explanation. At least some of these elements are preferably integrated on a common chip whose surface is shared by light sensitive regions of the avalanche photodiodes and circuits associated with individual avalanche photodiodes or groups of avalanche photodiodes for their evaluation and control. All the components can be accommodated in a compact manner in a sensor 10 and in particular in a housing.

A coaxial arrangement is achieved in FIG. 1, by way of example by an arrangement of the light transmitter 12 in front of the light receiver 22. Alternative coaxial arrangements, for instance by beam splitters, are equally possible.

FIG. 2 shows a schematic block diagram of a further embodiment of the optoelectronic sensor 10 with a biaxial arrangement. In this respect, the same reference numerals here and in the following designate the same or mutually corresponding features. The light transmitter 12 and light receiver 22 are next to one another in the biaxial or twin arrangement. FIG. 2 should primarily illustrate the variant variety of the constructive design of the sensor 10 and should show that the invention is not restricted to a specific design.

FIG. 3 shows a laser scanner as a further embodiment of the optoelectronic sensor 10. The transmitted light pulse 14 and the remitted light pulse 20 are here periodically guided through the monitored zone 16 with the aid of a rotating mirror 32 to scan a plane. A further deflection unit 34 is provided in the transmission path to direct the transmitted light pulse to the rotating mirror 32. It is conventionally a simple, small mirror that is now replaced by a beam splitter. Some of the transmitted light pulse 14 is thereby transmitted and reaches the light receiver 22 directly as a reference via a light return element 28 configured as a deflection mirror. This light guidance could also be used with a single-beam sensor and again underlines that the respective designs and light return elements 28 shown are purely by way of example.

A high number of different designs of laser scanners are possible, for example having a rotatable polygonal mirror wheel or having a measurement head with a light transmitter 12 and/or a light receiver 22 rotating overall. There are also other possibilities of extending the distance measurement to a larger monitored zone 16. A plurality of single-beam systems in accordance with FIG. 1 or 2 can thus be combined to form a sensing light grid having a plurality of mostly parallel beams that measures or monitors distances in each beam. Measurements can be made individually or group-wise with spatial resolution using the avalanche photodiodes 24 so that a 3D camera is created. Mobile systems are also conceivable in which the sensor 10 is movably installed.

FIG. 4 shows an exemplary simplified equivalent circuit diagram of a single avalanche photodiode 24 in Geiger mode. In practice, it is a semiconductor component whose design, not shown, is assumed as known here. The avalanche photodiode 24 shows the behavior of a diode 36, on the one hand. It has a capacitance that is represented by a capacitor 38 connected in parallel. The possible avalanche effect generates charge carriers whose origin is shown in the equivalent circuit diagram as a current source 40. The avalanche effect is triggered by an incident photon 42, with this process acting like a switch 44. There are then various possibilities of observing the output signal 46 which will not be looked at in more detail here.

In standby operation, a voltage above the breakdown voltage is applied across the diode 36. If an incident photon 42 then generates a charge carrier pair, this so-to-say closes the switch 44 so that the avalanche photodiode 24 is flooded with charge carriers via the current source 40. New charge carriers, however, only arise as long as the electrical field remains strong enough. If the capacitor 38 is discharged so much by the current source 40 that the breakdown voltage is fallen below, the avalanche self-quenches (passive quenching). The capacitor 38 then recharges until a voltage above the breakdown voltage is again applied to the diode 36. There are alternative embodiments in which the avalanche is recognized from outside and a discharge is thereupon triggered below the breakdown voltage (active quenching). An avalanche photodiode 24 thus has the ability to detect even individual photons and is therefore suitable for a highly sensitive light receiver 22.

FIG. 5 shows a block diagram of a reception system with a light receiver 22 and an evaluation unit 26. As already mentioned, circuits for the evaluation can be implemented directly in or at individual light reception elements 24, 24a or groups thereof so that the reception system 22, 26 can form a common chip. The specifically shown arrangement therefore does not imply any fixing to a specific layout, in particular with reference to the position of light-sensitive regions and evaluation regions. Alternatively, the evaluation takes place partly or completely outside a chip of the light receiver 22.

The reference channel having the reference reception elements 24a is shown in the upper part of FIG. 5; the measurement channel having the measurement reception elements 24 and respective associated evaluation elements is shown in the lower part. At the far right, information from the reference channel and the measurement channel is combined.

An electric start signal, here the laser trigger, that also controls the light transmitter 12 for the generation of the transmitted light pulse 14 is applied to the START input of TDC components 48, 50a-n. A reference time measurement for the reference channel and a plurality of time of flight measurements for groups of measurement reception elements 24 in the measurement channel thus start simultaneously. Instead, the start and reception point in time can also be fixed or stored in a different manner using TDC modules 48, 50a-n to determine the time of flight as their difference.

The received signals of the reference reception elements 24a are supplied to an edge detector 52. An AND operation 54 subsequently follows. The reference channel thus generates a common stop signal as soon as all the reference reception elements 24a have registered the first edge of the reference pulse that is guided to the STOP input of the responsible TDC module 48. In alternative embodiments, a minimum number m of n reference reception elements 24a can already be sufficient for the stop signal instead of all the reference reception elements 24a. It is additionally conceivable to generate a plurality of trigger signals from a plurality of reference reception elements 24a or groups of reference reception elements 24a. A plurality of reference time measurements can thus be carried out with the aid of additional TDC modules instead only one reference time measurement and their results are then averaged, for example,

In a similar manner, the received signals of a plurality of measurement reception elements 24 are combined and evaluated to generate a stop signal for the STOP input of the responsible TDC modules 50a-n in the measurement channel on reception of the remitted light pulse 14. For this purpose, the first edge is likewise preferably detected and a common decision is made for the combined measurement reception elements 24. This evaluation and combination is shown in simplified form in FIG. 5 as a respective group switching element 56a-n, for example with a time monoflop function. In this respect, an m from n decision can likewise be made; alternatively, a sum signal can be generated or specific measurement reception elements 24 are connected in a multiplexing to the TDC modules 56a-n. The plurality of groups, here rows for example, of measurement reception elements 24 produce a plurality of measurements of the time of flight. This can be used for a statistical evaluation, but also for a spatial resolution or for both.

The measured reference time between the laser trigger and the reception of the reference pulse is available in the reference channel after the reference time measurement at a reference store 58. The respective times of flight from the laser trigger to the reception of the remitted light pulse 20 are present by means of multiplexers 60 at the end of the measurement channel. The respective difference of the time of flight and the reference time is formed in a subtraction stage 62.

The result is, since the TDC modules 48, 50a-n were triggered simultaneously in the reference channel and measurement channel, a respective exact time of flight between the sensor 10 and the object 18 adjusted for internal signal paths and other interference. The reference time measurement and the time of flight measurement are, however, rectified in this process to eliminate the initially explained conventional blind region due to pulse overlaps. If an edge of the pulses is used at the transmission side and at the reception side for determining points in time, in particular the first or rising edge, the measurement is thus completely independent of the further progression of the pulses and thus also of the pulse width.

A plurality of measurements of the time of flight taking account of the reference are now available at the output of the subtraction stage 62 depending on the number of groups of measurement reception elements 24. The number can be further increased by measurement repetition using further transmitted light pulses 14. The individual measurement values are preferably statistically evaluated together, here by way of example gradually cumulated in a histogram 66 by means of demultiplexer 64, said histogram then being further evaluated. Effects of disturbance variables such as extraneous light or dark noise (DCR, dark count rate) can thereby be suppressed and the measurement accuracy can be increased. A large number of measurement elements 24, for example several thousand, or groups thereof and also a number of measurement repetitions are conceivable in dependence on the required response time of the sensor 10.

FIG. 6 additionally show an exemplary signal progression at different points of the reception system of FIG. 5. The measurement starts with the laser trigger 68. The rising edge of the laser trigger 68 starts both the TDC module 48 in the reference channel and the TDC modules 50a-n in the measurement channel. The light transmitter 12 converts the laser trigger 68 with a little delay into the optically transmitted light pulse 14 of the optical transmitted signal 70.

The reference reception elements 24a register the reference pulse 72a-m or its rising edge with a certain scatter. A common stop signal that ends the reference time measurement in the TDC module 48 is derived from this by an AND operation. The reference time is thus determined as the count 76 of the TDC module 48.

Even later, the remitted light pulse 20 is registered in the measurement reception elements 24. For simplification, only the received signal 78 of a single measurement reception element 24 is shown; a combination can also take place here as explained with reference to FIG. 5. The rising edge of the received signal 78 stops the associated TDC module 50a-n of the measurement channel. The time of flight is thus also determined as the count 80 of the TDC module 50a-n. As explained with reference to FIG. 5, it is then corrected by the reference time.

To summarize some of the ideas of the invention, the best reference measurement would naturally be achieved per se if the same channel were responsible for transmission and reception. Since, however, the pulses cannot be of any arbitrary shortness, approximately 500 ps is realistic here, a blind region is then created by overlapping pulses. The blind region can be eliminated by the described reference measurement and time of flight measurement in accordance with the invention in that the respective result of the reference time measurement is deducted from the time of flight measurement. An independence from the pulse width is achieved by determining points in time with reference to edges, in particular to the first or rising edge.

1. An optoelectronic sensor for determining the distance of an object in a monitored zone in accordance with a pulse-based time of flight process, the optoelectronic sensor comprising
a light transmitter for transmitting a light pulse;
a light receiver that has a plurality of avalanche photodiode elements, with each of the plurality of avalanche photodiode elements being able to be biased by a bias voltage above a breakdown voltage and thus being operable in a Geiger mode, wherein at least one avalanche photodiode element is configured as a measurement reception element and receives the light pulse remitted by the object and at least one avalanche photodiode element is configured as a reference reception element and receives some of the transmitted light pulse within the sensor as the reference pulse; and
an evaluation unit that is configured to determine, from the received signals of the measurement reception element and of the reference reception element, a time of flight between the transmission of the light pulse and the reception of the remitted light pulse and from this the distance of the object,
wherein the evaluation unit is configured:
to start a reference time measurement and a time of flight measurement by way of an electric start signal;
to end the reference time measurement on reception of the reference pulse on the reference reception element and to end the time of flight measurement on reception of the remitted light pulse on the measurement reception element; and
to determine the time of flight as a difference of the results of the time of flight measurement and of the reference time measurement.

2. The sensor in accordance with claim 1,
wherein the evaluation unit is configured to start the time of flight measurement with an edge of the electric start signal and/or to end it with an edge of the remitted light pulse.

3. The sensor in accordance with claim 2,
wherein the evaluation unit is configured to start the time of flight measurement with a first edge of the electric start signal and/or to end it with a first edge of the remitted light pulse.

4. The sensor in accordance with claim 1,
wherein the evaluation unit is configured to start the reference time measurement with an edge of the electric start signal and/or to end it with an edge of the reference pulse.

5. The sensor in accordance with claim 4,
wherein the evaluation unit is configured to start the reference time measurement with a first edge of the electric start signal and/or to end it with a first edge of the reference pulse.

6. The sensor in accordance with claim 1,
wherein the evaluation unit is configured to carry out a plurality of time of flight measurements using one of a plurality of measurement reception elements and groups of measurement reception elements and to evaluate the times of flight thus determined together to determine the distance of the object.

7. The sensor in accordance with claim 1,
wherein the evaluation unit is configured to repeat the reference time of flight measurement and the time of flight measurement and to evaluate the times of flight thus determined together to determine the distance of the object.

8. The sensor in accordance with claim 1,
wherein a plurality of reference reception elements are provided and the evaluation unit is configured to end the reference time measurement as soon as a minimum number of reference reception elements have received the reference pulse.

9. The sensor in accordance with claim 1,
wherein a plurality of reference reception elements are provided and the evaluation unit is configured to carry out the reference time measurement multiple times with one of the reference reception elements and groups of reference reception elements.

10. The sensor in accordance with claim 1,
wherein the evaluation unit has a respective at least one TDC for the reference time measurement and the time of flight measurement.

11. The sensor in accordance with claim 1,
wherein a light return element is arranged in the sensor to conduct the reference pulse to the reference reception element.

12. The sensor in accordance with claim 1,
wherein the at least one reference reception element is separated from the remaining light reception elements by an optical barrier.

13. A method of determining the distance of an object in a monitored zone in accordance with a pulse-based time of flight process, the method comprising the steps of:
transmitting a light pulse; and
on a light receiver that has a plurality of avalanche photodiode elements that are each biased by a bias voltage above a breakdown voltage and are thus operated in a Geiger mode—receiving the light pulse remitted by the object at at least one avalanche photodiode element as a measurement reception element and receiving some of the transmitted light pulse directly, without an optical path passing through the monitored zone, as a reference pulse at at least one avalanche photodiode element as a reference reception element, and
determining a time of flight between transmission of the light pulse and reception of the remitted light pulse from the received signals of the measurement reception element and of the reference reception element, and
determining the distance of the object therefrom,
wherein a reference time measurement and a time of flight measurement starts with an electric start signal; the reference time measurement is ended on reception of the reference pulse on the reference reception element and the time of flight measurement is ended on reception of the remitted light pulse on the measurement reception element; and the time of flight is determined as a difference of the results of the time of flight measurement and the reference time measurement.
